(19) United States
(12) Patent Application Publication
(10) Pub. No.: US 2005/0044730 A1
(43) Pub. Date: Mar. 3, 2005

(54) Sharpener

(76) Inventor: Ernst Fischer, Langenwendelbach (DE)

Correspondence Address: GREER, BURNS & CRAIN, 300 S WACKER DR, 25TH FLOOR, CHICAGO, IL, 60606, US

(21) Appl. No.: 10/647,661

(22) Filed: Aug. 25, 2003

Related U.S. Application Data
(63) Continuation of application No. PCT/EP02/01972, filed on Feb. 25, 2002.

(30) Foreign Application Priority Data
Feb. 25, 2001 (DE) 101 09 167.2
Jul. 30, 2001 (DE) 101 37 096.2

(51) Int. Cl. B43L 23/00

(52) U.S. Cl. 30/454; 30/453

(57) ABSTRACT

A sharpener for pencils, and especially for pencils with a rotation-symmetrical cartridge or for pencils whose cartridge is arranged inside of a cartridge carrier, whose cross-section runs perpendicular to the length axis is non-hexagonal and non-circular, includes at least one housing, a cutting device that is connected with the housing, a holding device for the pencil that is at least partially contained in the housing, and a force feed device which guides the holding device along a pre-determined movement path in the housing.

### BACKGROUND

The invention concerns a sharpener for pencils having a color cartridge, such as graphite pencils, crayons and in particular cosmetic pencils and similar items.

Existing sharpeners have a housing with an opening into which a pencil to be sharpened can be inserted. The one end of this pencil thereby comes into contact with an edge arranged at an angle to the length axis of the pencil so that a rotating movement or a screw-like movement of the pencil creates a conical point at the end of the pencil around its length axis.

These familiar sharpeners can be used for sharpening pencils with an essentially cylindrical color cartridge that have a carrier body surrounding the color cartridge, which is usually made of wood and has a circular or hexagonal cross-section.

For many types of pencils, in particular cosmetic pencils and similar items, there is a desire to shape a point that is non-conical. This is due in part to the fact that the material used for this point is very soft and that, on the one hand, there is desire for steady positioning of the color shaft and, on the other hand, for a contact surface that is not too large for application of the material from the point.

The task of the invention, therefore, is to create a sharpener for sharpening pencils, which is technically configured in a different manner. In particular, the task of the invention is to create a sharpener for sharpening pencils that can be used to sharpen pencils that have essentially any type of carrier body cross-section and can sharpen the point on the color cartridge in a reliable manner.

### SUMMARY

In accordance with the invention, a pencil sharpener is proposed that has a cutting device, a holding device for the pencil a, at least one housing and a force-feeding device.

In accordance with the invention, the pencil is received in particular by the holding device. The holding device thereby preferably grabs the pencil around its exterior. The holding device is arranged within the sharpener is such a way that a free end of the pencil, the end that will be sharpened, is located outside of the holding device so that the cutting device can make contact with it. Preferably, the pencil will be held inside of the holding device in a rotationally fixed manner so that rotation around an axis parallel to its length axis will be prevented. It is especially preferred that the pencil to be sharpened is received in the holding device in a form-fitting manner. Preferably the pencil will be placed in the holding device so that it may move in an axial direction with respect to its length axis and so that it can be moved in the direction of the cutting device.

The housing will preferably have at least two housing parts, of which one will be a lid. The housing parts are connected with one another. In particular the housing parts are welded, specifically using ultrasound welding, glued or screwed together.

The force-feed device has at least one feed element and at least one feed track in which the feed element is force fed upon sharpening of the pencil.

The feed track is formed in particular from a cam or at least contains such a cam. Especially preferred is to form the feed track using a groove. It is preferred that the feed track is formed from a threading. Especially preferred is to form the feed track from a groove that has a constant or varying groove depth. A force feed that is realized by means of a varying groove depth or a force feed realized by means of the groove path or the combination of these force-feeds is particularly preferred in accordance with this invention.

According to a particularly preferred configuration of the invention, there is a disk that stretches concentrically around the holding device, which can hold the pencil whereby there is a groove with a varying groove depth running along the perimeter on the exterior of this disk so that at least one feed pencil that is connected with the housing extends in and the position of the pencil or the holding device opposite the housing changes in accordance with predetermined characteristics.

It is especially preferred to arrange on one or both end-walls grooves on a disk that stretches concentrically around the holding device, into which feed pencils connected solidly to the housing extend whereby these grooves match with respect to their paths or are at least distinguished by their path.

The feed track or the groove is a closed track. The feed element is particularly preferred to be formed as a feed pencil, which is specifically fedto in a groove.

Several differently shaped feed tracks are preferable.

Already the use of a feed groove offers the advantage of being able to guide the holding device in a predetermined manner upon rotation around the axis.

The use of two feed grooves that are arranged on both sides of the disk-shaped seat of the holding device and into which the respective pencil that is connected solidly with the housing reaches, offers the significant advantage that the movement track of the pencil can be selected in any manner opposite the knife fastened to the housing.

For an elliptical pencil, it is preferably the case that one feed track ensures that the pencil can be moved up and down whereas the other feed track causes the pencil to be moved against the blade and then away from the blade. This creates a chisel-shaped edge that can be used with thick color pencils or cosmetic pencils to great advantage.

In particular, a well-suited selection of feed grooves can ensure that the position of the color cartridge against the blade is optimal and, in particular, that the free angle need for a good cut will be in the respective optimal range.

A sharpener as described in the invention can be used in particular for pencils that have a random shaped color cartridge at its cross-section. This color cartridge can, in particular, be formed in a non-rotational symmetrical manner. Preferably the cross-section of this color cartridge will have an elliptical shape. The cartridge carrier can also have essentially any shape and, in particular, have an elliptical shape.

In addition, a sharpener as described in the invention can be used for a number of other shapes, in particular corresponding to the shape of its force feed device, of the color cartridge carrier, which, in particular, has a wood cover essentially running along the color cartridge axis, which surrounds the color cartridge and thereby offers special protection to it.

Especially preferred are two grooves on the respective end-walls, which serve to guide a pencil placed firmly in the housing.

Especially preferred is arrangement of the cutting device, i.e. specifically the blade, in a fixed manner opposite the housing. Especially preferred is connection of the blade in a fixed manner with the housing, which in particular is achieved by means of a screw connection or similar type of connection.

It is preferred that the pencil is received in the holding device in a rotationally fixed manner in relation to its length axis whereby the holding device, along with the pencil, is arranged opposite the cutting device so it can move. The pencil will preferably be received in the holding device in a form-fitting manner. Upon sharpening of the pencil, the holding device, and thereby the pencil will move opposite the cutting device.

The pencil will preferably be received in the holding device so it may be moved in an axial direction so that it can be moved in the direction of the cutting device and the cutting surface of the pencil can be shaped by means of a rotating movement of the pencil relative to the cutting device.

In accordance with an especially advantageous configuration of the invention, the force-feed device or the path of the groove, into which a pencil reaches, or the cam is formed is such a way that the free angle upon sharpening is constantly between 2° and 10°, preferably mainly between 3° and 5°, and is especially preferred to be 3°. The free angle is preferably held constant during sharpening of the pencil. It is also preferred that the free angle lies within an interval of 1° when sharpening.

It is preferable that the sharpener has a sealing device. This sealing device specifically insulates the feed tracks so that the feeding mechanism does not become hindered by invasive materials, such as shavings or similar materials.

The sealing disk is, in particular, made of a material that has POM or polyamide or Derin or Hostaform, whereby Derin and Hostaform are product names.

The sharpener also has a feed track that makes it possible to sharpen an elliptical pencil with ellipse ratios of essentially 1.3:1 through 1.6:1 with an essentially free angle that remains equal. It is especially preferred that that ellipse ratio of the pencil is essentially 1.45:1. Other ellipse ratios are also preferred for other shapes of the pencil in accordance with the invention.

Preferably the sharpener will have a container that can be used to catch shavings that are cast off during sharpening. Such a container can be configured as a collection cap or a shaving capsule container which connects essentially to the blade and is made to be transparent.

Preferably the feed disk will be guided between to plane surfaces, which prevent movement of the feed disk in an axial direction, i.e. perpendicular to the flat plane surface.

Preferably, there will be an opening in the exterior wall of the housing through which a pencil can be inserted into the housing for sharpening, covered at least partially by a covering that is, in particular, formed as a disk. This covering will be spring-loaded against the housing from the interior side of the housing. The covering will have an opening through which the pencil and, if necessary, a part of the feed device for this pencil will reach. The opening is thereby designed in such a manner that the holding device or the pencil rests on the surrounding wall of the opening. The housing is thereby, in the area of the opening through which the pencil is inserted for sharpening and in which it is moved perpendicular to its length axis upon sharpening, essentially covered. The covering is thereby arranged perpendicular to the length axis of the pencil opposite the housing so it can move and is pressed against the housing using a spring in each of the resulting possible relative positions opposite the housing.

The sharpener is preferably made, at least in part, of a high-grade synthetic material, such as POM. In particular, the feed track and/or the holding device and/or the feed pencil and/or the container are made from a (high-grade) synthetic material.

The cutting device, or the blade, is preferably made from hardened steel. In particular it is planned that the holding device contains the feed casing. Especially preferred is the holding device of the rotating compartment, or the reverse.

In a preferred formation, the sharpener has a rotating compartment that has a feed casing with a wall section reaching in the perimeter direction. This wall section limits an empty space in which the pencil can be received upon sharpening, in particular relevant to it shape. In this preferred formation the rotating compartment has another support section over which this rotating compartment can be supported in an axial direction.

Preferably the support section is formed in such a way that it runs in a radial direction.

It is preferable that the feed casing has a varying wall thickness in the perimeter direction. It is especially preferred that the wall thickness of the feed casing is essentially constant in an axial direction.

The path of the wall thickness of the feed casing in the perimeter direction will preferably influence the shape of the pencil to be sharpened.

It is especially preferable that the support section is arranged to the axial end of the feed casing. The support section is preferably supported on a housing section and in particular in an axial direction. Preferably the support section is supported in an axial direction on a housing wall section that essentially runs in a radial direction.

Preferably there is a housing compartment that is made of multiple parts, for example, a two-part housing. The housing compartment can be formed in such a way that it has a separating level that is essentially arranged perpendicular to the length axis. In a preferred formation there are at least three cam feed surfaces arranged on or in the housing compartment.

In particular there can be a two-part housing compartment and at least one cam can be arranged on each of these parts on the side facing the housing interior.

It is further preferred that the housing compartment has a wall section in an axial direction on both sides and one running in a radial direction that is equipped with an opening. The feed casing can run through this opening. In an especially preferred configuration, at least one limitation wall of this opening will work as a cam feed surface.

It is especially preferred that there will be three cams that are situated next to each other in an axial direction.

Preferably at least one of the cams or a cam seat will have an opening that functions, for example, as an input/output opening and runs radial within itself in an axial direction. The feed casing can be inserted through this opening. This opening is preferably formed in such a way that the feed casing can be received in a form-fitting manner, in particular in a rotationally fixed manner.

It is preferred that at least three cams are connected with each other as one piece.

It is further especially preferred that at least three cams are connected in one piece with the feed casing.

Preferably this housing is insulated, particularly on the end. One or more seals can be used for this purpose.

In a preferred formation, there are at least two cam feeds arranged at an angle of 120° to each other.

It is further preferred that at least two cam feeds are arranged at an angle of 60° to each other. Preferably the cam feeds can also be arranged whereby at least two cam feeds are used whose defaults have an angle of 120°.

### BRIEF DESCRIPTION OF THE DRAWINGS

In the following the invention is described in greater detail using the figures that are not intended to limit the invention.

The figures illustrate the following:

FIG. 1 a first example of a configuration of the invention in a schematically, partially cut view;

FIG. 2 a first cutaway view of the display in FIG. 1;

FIG. 3 a second cutaway view of the display in FIG. 1;

FIG. 4 the position of the knife blade in first positioning of the pencil;

FIG. 5 the position of the knife blade in second positioning of the pencil;

FIG. 6 the position of the knife blade in third positioning of the pencil;

FIG. 7 the position of the knife blade in a fourth positioning of the pencil;

FIG. 8 a second example configuration of the invention in a schematic, partial cutaway view;

FIG. 9 a cutaway view along the line 9-9 from FIG. 8;

FIG. 10 a side view from the direction of the arrow 126 from FIG. 8; and

FIG. 11 a cutaway view along the line 11-11 from FIG. 10;

FIG. 12 an example configuration of the invention in schematic display;

FIG. 13 a cutaway view from the view of line 13-13 in FIG. 12;

FIG. 14 a cutaway view from the view of line 14-14 in FIG. 12;

FIG. 15 a cutaway view from the view of line 15-15 in FIG. 12;

FIG. 16 a cutaway view from the view of line 16-16 in FIG. 12;

FIG. 17 a cutaway view from the view of line 17-17 in FIG. 12;

FIG. 18 an example configuration of the invention in schematic display;

FIG. 19 a cutaway view from the view of line 19-19 in FIG. 18;

FIG. 20 a cutaway view from the view of line 20-20 in FIG. 18;

FIG. 21 a cutaway view from the view of line 21-21 in FIG. 18;

FIG. 22 a cutaway view from the view of line 22-22 in FIG. 18;

FIG. 23 an example configuration of the invention in schematic display;

FIG. 24 a cutaway view from the view of line 24-24 in FIG. 23;

FIG. 25 a cutaway view from the view of line 25-25 in FIG. 23;

FIG. 26 a cutaway view from the view of line 26-26 in FIG. 23;

FIG. 27 a cutaway view from the view of line 27-27 in FIG. 23;

FIG. 28 an example configuration of the invention in schematic display;

FIG. 29 a cutaway view from the view of line 29-29 in FIG. 28;

FIG. 30 a cutaway view from the view of line 30-30 in FIG. 28;

FIG. 31 a cutaway view from the view of line 31-31 in FIG. 28;

FIG. 32 a cutaway view from the view of line 32-32 in FIG. 28;

FIG. 33 an example configuration of the invention in schematic display with partial cutaway view;

FIG. 34 an example configuration of the invention in schematic display with partial cutaway view.

### DETAILED DESCRIPTION

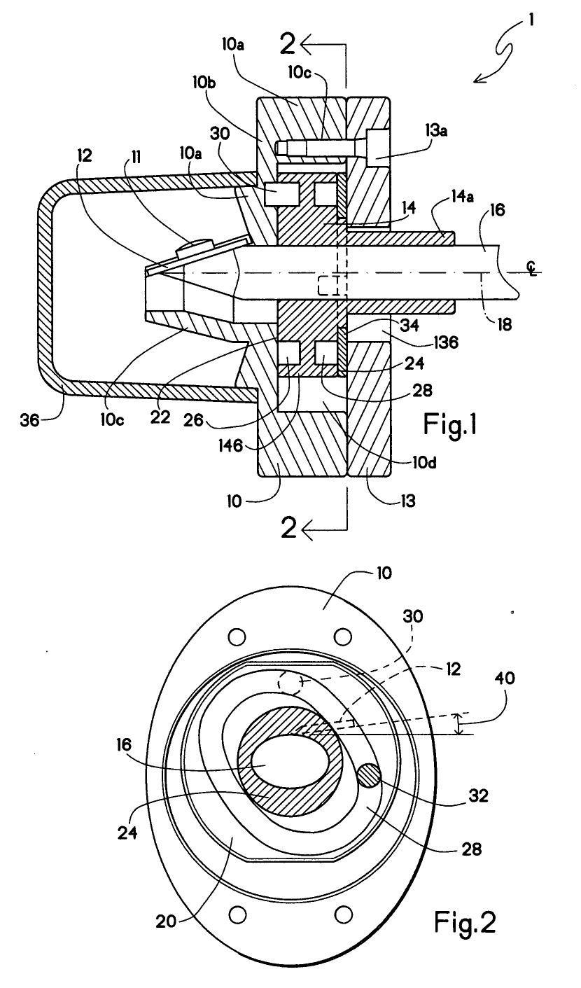

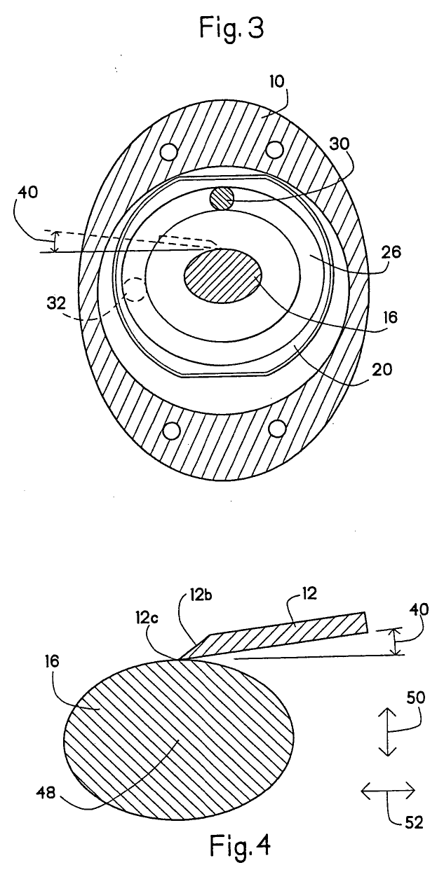

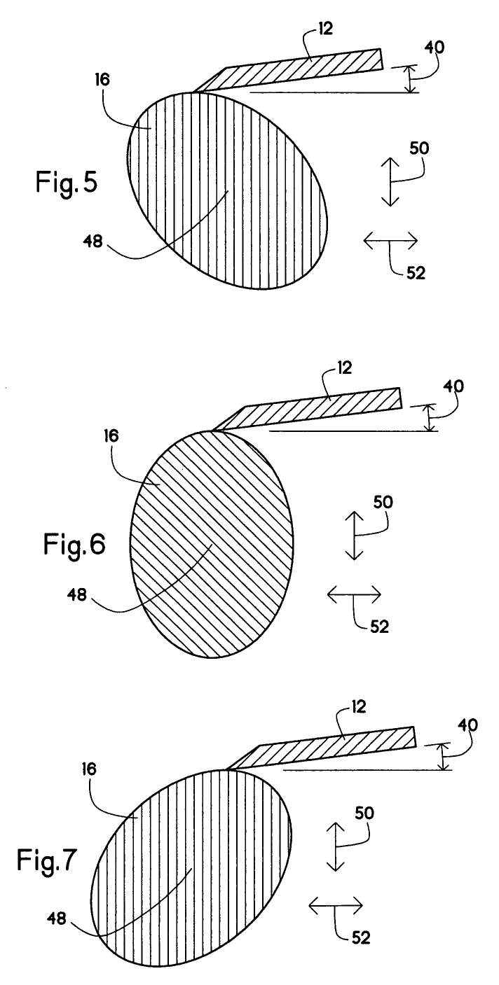

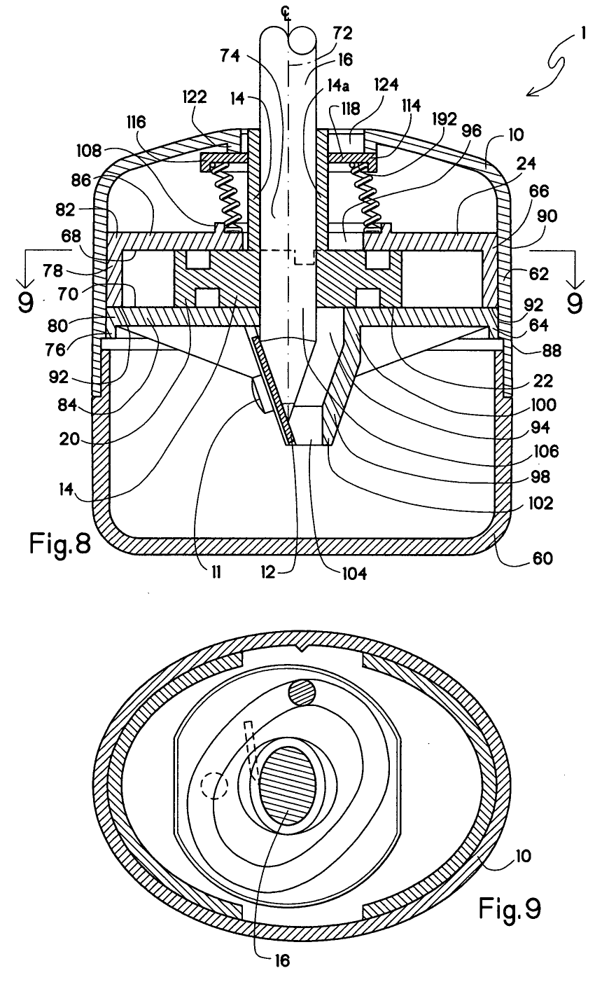

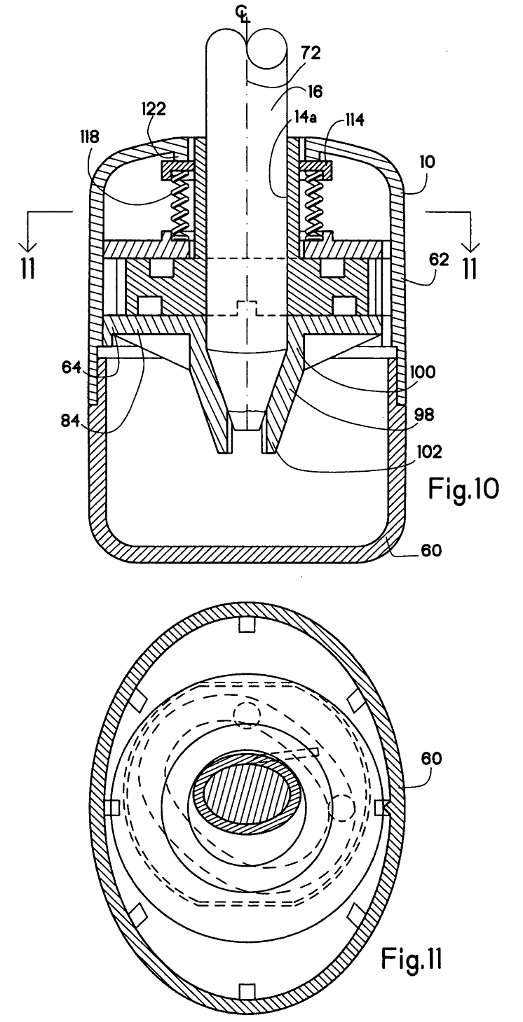

FIG. 1 shows an example configuration of the sharpener 1 described in the invention that is designed to sharpen essentially elliptical cosmetic pencils with an essentially chisel-shaped point.

The sharpener has a housing, which in its entirety has been designated with the reference number 10. The housing has an essentially cylindrical section 10a that is partially covered by a ring plate 10b.

An essentially cone-shaped tapering 10c has been shaped onto this ring plate 10b, upon which the knife blade 12 made of hardened steel has been fastened using a screw 11.

The knife blade has been formed in a conventional manner, i.e. it has been configured as an essentially flat plate that has a blade edge 12b and a point 12c (FIG. 4) on the turned surface of the blade.

The inner cylindrical space 10d of the housing 10 is closed with a housing lid 13 that is essentially shaped in a circular fashion and fastened with screws 13a onto the housing 10 that screwed into screw taps 10e in the housing 10.

Please not that instead of this screw fastening, a connection between the housing lid and the housing can be used.

A holding device is arranged within the housing, which in its entirety is designated with the number 14.

The holding device 14 consists of a first tube-shaped holding part 14a adapted to the contour of the pencil to be sharpened and an essentially disk-shaped part 14b that are preferably connected together as one part.

The holding device 14 is received in the cylindrical hollow space 10a of the housing 10 in such a way that the holding device can be rotated opposite the housing.

For this purpose the housing lid 10 is equipped with a drill-hole 13b that is formed in such a way that it enables an undisturbed rotation movement of the tube-shaped attachment 14a.

As already executed, the tube-shaped attachment 14a is formed in such a way that at least the inner contour is adapted to the outer contour of a pencil 16 with a length axis 18.

The disk-shaped part 14b of the holding device has a first end wall 22 and a second end wall 24. There is a first groove 26 in the first end wall and a second groove 28 in the second end wall 24. A first pencil 30 reaches into the groove 26 that is held firmly in the housing 10 and a pencil 32 reaches into the second groove 28 that is held firmly in the housing lid 13.

The dimensions of the first and second groove 26, 28 and of the first 30 and second pencil 32 have been chosen in such a way that the pencils can slide into the grooves.

There is also a sealing ring 34, which preferably is made of synthetic material and is placed between the disk-shaped part 14b and the lid 13. This groove serves only for purposes of insulation and also makes movement of the circular-shaped part 14b easier.

As can be clearly seen in FIG. 1, an essentially conical, cup-shaped container 36 is placed on the disk-shaped attachment 10b, which is set upon an attachment 10g of the circular part 10b. This container preferably consists of synthetic material and it is especially preferred that this synthetic material is transparent.

FIG. 2 shows a partial cutaway view along line 2-2 in FIG. 1. Here the shape of the groove 28 can be seen clearly.

FIG. 3 shows another cutaway display from which the shape of the groove 26 appears. The shape of the groove or grooves is determined in particular by a reverse calculation from the desired shift movement when sharpening.

As can be seen in FIG. 3, the first groove 26 is formed in an essentially elliptical manner whereby the elliptical formation essentially corresponds to the corresponding opening of the tube-shaped attachment 14a of the holding device. In other words, the curve track 26 is essentially elliptical and concentric to the elliptical contour of the pencil 16.

As can be seen in FIG. 2, the second groove is also essentially shaped in an approximate elliptical manner, but the ellipse here is, roughly stated, tipped at an angle of 45°. One could also call it a distorted ellipse.

The function of the sharpener described in the invention is now described in reference to FIGS. 4 thru 7:

Because the circular attachment 14b of the holding device 14 is held between the disk-shaped attachment 10b of the housing and the housing lid 13, it cannot move in a direction along the axis 18 of the pencil. With respect to the housing 10, the disk-shaped attachment 14b thereby executes a flat movement. The movement of a body may be presented familiarly as the sum of a translation movement with a rotation movement around the respective rotating axis in question. A flat movement, as in the preceding instance, thereby yields three degrees of freedom, specifically two movement possibilities in the X and Y planes (which is not displayed and which would run perpendicular to the axis 18 in this instance) and a rotation movement.

Because both feed pencils 30 and 32 are anchored firmly in the housing and both feed grooves 26 and 28 on the other had are arranged firmly in the circular attachment 14b, there are two fixed points for the movement of the disk-shaped part 14b in reference to the housing 10 so that only one degree of freedom remains.

This means that a rotation of the pencil 16 leads to an exact pre-determined movement of the holding device 14 in reference to the housing 10 and thereby in reference to the knife blade 12 that is connected firmly to the housing.

FIGS. 4 thru 7 illustrate how this movement is formed.

The knife 12 is arranged in such a way that it lies at a free angle 40 on the point of the pencil to be sharpened. When the pencil 16 is rotated, it is moved, as shown in FIG. 4 thru 7, in such a way up and down along the arrow direction 50 and back and forth along the arrow direction 52 so that this free angle is maintained in all positions of the pencil.

First, this achieves the exact predetermined shape of the point of the pencil, a chisel-shaped point in the preceding case.

Second, maintaining the constant free angle results in a situation where the cutting result is even and pressure is not placed in a direction vertical to the pencil (seen in the direction of the display in FIG. 4 thru 7) during the cutting process.

This brings about an exact forced guidance of the position of the pencil in relation to the knife blade in a technically simple manner.

Note that the chisel-shaped point on an elliptical pencil is the preferred application of this invention. The solution described in the invention makes it possible, however, to realize the greatest number of different shapes that can be made through the linear stratification of two curved surfaces to two fixed points, which are the pencils.

FIG. 8 shows a second example configuration of the invention in a schematic display.

The sharpener 1 has a housing 10 upon which a detachable lid 60 is fastened. The housing 10 has a thin exterior wall 62. Within the thin exterior wall 62, a first intermediate part 64 and a second intermediate part 66 are arranged within the housing 10.

The first 64 and the second intermediate part 66 each has an essentially flat area 68, 70 which essentially runs perpendicular to the length axis 72 of a channel 74 that is arranged within the holding device and serves to receive a pencil 16 to be sharpened.

The first 64 and the second intermediate part 66 are positioned in a rotationally fixed manner in the housing in relation to the length axis 72. The first 42 and the second intermediate part 66 each have a flange 76, 78 which runs in the exterior area 80, 82 of a plate 80, 86 containing the flat area 68 or 70 perpendicular to the flat area 60, 70. With their respective exterior upper surfaces 88, 90 turned away from the length axis 72, the surrounding flanges 76, 78 lay on the exterior wall 62. The end wall 92 turned away from the plate 86 of the second intermediate part 96 is supported against the first intermediate part 64. The plate 84 of the first intermediate part 64 and the plate 86 of the second intermediate part 66 each have an essentially circular opening 94, 96. In the area of the opening 94 of the first intermediate part 96, an attachment 98 with a cylindrical part 100 runs from the page 84 in the direction away from the second intermediate part 66, as well as a conical part 102 formed onto it, whereby the cylindrical part 100 and the conical part 102 are each configured hollow.

On the end turned away from the second intermediate part 66, the conical part 102 has an opening 104, which connects the interior of the conical part 102 with the interior of the lid 60. A knife blade 12 is mounted on the attachment 98 using a screw 11 at an angle to the length axis.

There is a cam 20 that runs parallel to the flat areas 60,66 between the first intermediate part 64 and the second intermediate part 66, which makes contact with the first 64 and the second intermediate part 66 and is arranged in a rotating manner in relation to the length axis 72 opposite the first intermediate part 64 and the second intermediate part 66. The cam 20 has orbiting grooves 26, 28 on both of its end walls 22, 24, that make contact with the first intermediate part 64 and the second intermediate part 66, which are asymmetrically arranged in relation to a plane that stretches through the cam 20. Respective pencils run through these grooves 26, 28, which are fastened on the first intermediate part 64 and the second intermediate part 66 so that the movement plane, which the cam 20 can execute opposite the first intermediate part 64 and the second intermediate part 66 through synchronous operation of the pencil with the grooves 26, 28, is determined. The cam 20 has an opening 106. A tube-shaped attachment 14a is formed onto the cam 20 around this opening on the side turned away from the first intermediate part 64, which runs through the opening 96 of the plate 86 pf the second intermediate part 66.

The plate 86 of the second intermediate part 66 also has a flange 108 running perpendicular to the flat area 68 further on its side turned away from the first intermediate part 64, which is formed in an orbiting manner and server to support the spring element 110, which is formed in particular as a spiral spring and supports itself against the second intermediate part 66. The field element 112 supports itself on the second end 112 against a disk 114 with an orbiting flange 116.

This disk 114 has an adapted opening 118 on the exterior contour of the tube-shaped attachment 14a through which this tube-shaped attachment runs.

The disk 114 runs essentially perpendicular to the length axis 72 and supports itself against the housing 10 using its end wall turned away from the field element 110. For this purpose, the housing 10 in particular has a tube-shaped attachment 122 that surrounds the length axis 22. The disk in this way covers an opening 124 that runs in the exterior wall 62 of the housing 10 and has an opening surface that is larger that the surface defined by the exterior perimeter of the tube-shaped attachment 14a.

FIG. 9 shows a cutaway display along line 9-9 from FIG. 8.

FIG. 10 shows a side view from the direction of the arrow 126 from FIG. 8.

FIG. 10 in particular illustrates that the disk 114 is arranged in the direction perpendicular to the length axis 72 in a moveable manner opposite the housing 10 and the tube-shaped attachment 122 of the housing 10. The respective position of the disk 114 opposite the housing 10 is specifically determined by the respective relative position of the pencil 16 and the tube-shaped attachment and/or the cam 20 relative to the housing 10. The disk 114 pressed by the working of the field element 110 against the housing 10 follows the plane perpendicular to the length axis 72, in particular the movement of the tube-shaped attachment 14a, because it is positioned with its opening outward toward the tube-shaped attachment. The field element 110 prevents the disk 114 from falling from the housing 10 and on the other side enables a flexible movability of the disk 114 corresponding to the movability of the tube-shaped attachment 14a.

FIG. 11 shows a cutaway view along the line 11-11 from FIG. 10.

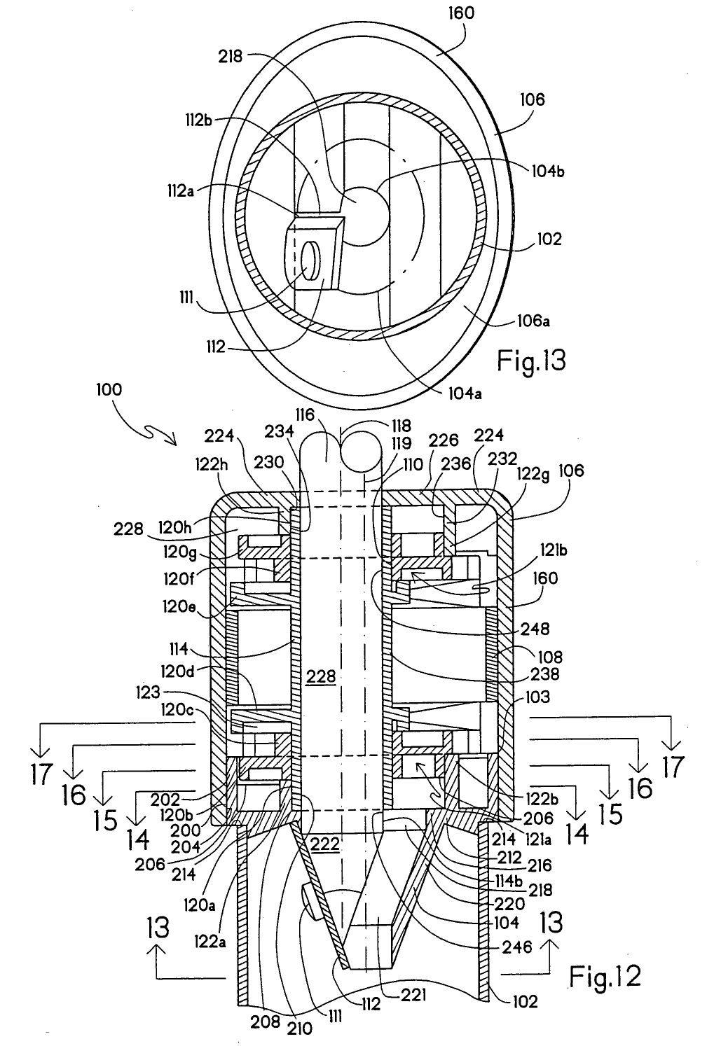

FIG. 12 shows an example configuration of a sharpener described in the invention.

The sharpener 100 has a cap 102, a housing 103 a housing compartment 108 and a rotation compartment 110.

A pencil 116 is also displayed in FIG. 12 with a length axis 118 that runs into the sharpener 100. This pencil 116 is not a component of the sharpener 100 itself.

The housing 103 is configured in multiple parts and has a first housing part 104 and a second housing part 106.

The first housing part 104 is inserted into the second housing part 106 and is supported by the exterior top surface 200 of its first wall section 202 on the interior top surface 204 of the second housing part 106.

There is a second cam feed 122b on the interior top surface 206 of the first wall section 202 that runs within in radial direction that can work together with a second cam 120b.

In a radial direction within the first wall section 202, a second wall section 208 has been arranged upon whose interior top surface 210 that lies within in a radial direction there is a first cam feed 122a that can work together with a first cam 120a.

The first 202 and the second wall section 208 are connected via a third wall section 212 of the first housing part 104 that runs essentially inside in a radial direction, has a ledge 214 upon which a cap 102 can rest, and has an opening 218 at its end 216 positioned within in a radial direction.

Against the third wall section 212 there is a one-piece fourth wall section 220 that is essentially in the area of the opening 218, which tapers in the direction away from this third wall section 212 and the point 222 of the pencil 116 is received in its interior space 221 for sharpening.

A detachable knife blade 112 fastened on the fourth wall section 220 using a screw 111 runs through a—preferably slit-shaped—opening of the fourth wall section 220.

The second housing part 106 is formed essentially in the shape of a bowl and has a housing casing 160, that is preferably a wall area that is formed in an essentially elliptical shape, as well as a side cover wall 224 that is shaped to the housing casing as one part and runs essentially within in a radial direction. This cover wall 224 has an opening 226 through which the pencil 116 can be inserted into the interior of the housing 228.

A fifth 230 and a sixth wall section 232 run from this cover wall 224 in the area of the opening 226 in to the housing interior 228, whose interior top surfaces 234, 236 that lie inside in a radial direction run parallel to the length axis 118 of the feed casing 114.

The eighth cam feed 122h is arranged on the interior top surface 234, which works together with the eighth cam 120h.

The seventh cam feed 122g is arranged on the interior top surface 236, which works together with the eighth cam 120g.

The housing compartment 108 that can basically be formed as one piece or multiple pieces is formed in two pieces in the formation illustrated in FIG. 8 and is fitted using light pressure into the housing 103. The separating level of both parts of this housing compartment 108 runs essentially through a central length axis 119 of the housing 103 whereby these parts of the housing compartment 108 are essentially arranged in a mirror image symmetrical to this separating level. Both parts of the housing compartment 108 are supported against each other in the direction of the perimeter.

Both parts of the housing compartment 108 can, according to how they are set opposite each other, basically form an essentially closed case surface or an unclosed, at least not completely closed, case surface.

In the configuration shown in FIG. 12, both parts of the housing compartment 108, according to how they are set opposite each other form an essentially unclosed or not completely closed case surface. This is realized in the configuration shown in FIG. 12 in such a way that both parts of the housing compartment each have an essentially closed combined wall section that forms a case section that is configured to be free of openings, which runs essentially parallel to the length axis 118 of the housing compartment 108 and over a part section in the perimeter direction. Flap-like extensions are connected to this combined and breach-free case section of both parts of the housing compartment, which run in the perimeter direction.

The case surface of the housing compartment 108 runs in the area of these flap-like extensions in the direction of the length axis of this housing compartment 108—not over the entire length of this compartment 108. The flaps of the different parts of the housing compartment 108 are supported against each other in the perimeter direction. In the area of these flaps of the different parts of the housing compartment, the exterior perimeter measurement is formed in comparison to the interior perimeter measurement of the housing casing 160 in such a way that inserting the housing compartment 108 into the housing 103 generates a light pressure fitting.

The housing compartment 108 has a third cam feed 122c that works together with a third cam 120c, a fourth cam feed 122d that works together with a fourth cam 120d, a fifth cam feed 122e that works together with a fifth cam 120e, and a sixth cam feed 122f that works together with a sixth cam 120f.

The rotation compartment 110 also has a feed casing 114 with a non-rotational symmetrical elliptical case-like wall area 238 that is connected to the third 120c, fourth 120d, fifth 120e and sixth 120f cam to form one piece.

The cams 120a, 120b, 120c, 120d, 120e, 120f, 120g, 120h, have been arranged on the exterior top surface of this rotation compartment 110.

The first 120a and the eighth cam 120h are each formed from a section of the exterior top surface 240 of the case-like wall area 238 of the feed casing 114 that is positioned outside in a radial direction. The disk-shaped cams 120b, 120c, 120d, 120e, 120f, 120g run in a radial direction from. this exterior top surface 240 of the case-like wall section 238, which if necessary have gaps 123—as indicated by the reference symbols. The thickness of these disks is preferably between 1 mm and 10 mm and is especially preferred to be essentially 3 mm. But other measurements can be used.

The first 120a, the second 120b, the third 120c and the fourth cam 120d are arranged into a first group 242 and the fourth 120e, the fifth 120f, the sixth 120g and the seventh cam 120h are arranged into a second group 244.

The cams 120a, 120b, 120c, 120d of the first group 242 are arranged in this sequence are placed in an axial direction and neighboring each other whereby—in the configuration as illustrated in FIG. 12—two respective neighboring cams 120a, 120b, 120c, 120d are arranged essentially against each other with the cams 120a, 120b, 120c, 120d of the first group 242 in an axial direction.

The cams 120e, 120f, 120g, 120h of the second group 244 are arranged in this sequence are placed in an axial direction and neighboring each other whereby—in the configuration as illustrated in FIG. 12—two respective neighboring cams 120e, 120f, 120g, 120h are arranged essentially against each other with the cams 120e, 120f, 120g, 120h of the first group 244 in an axial direction.

The first group 242 is arranged in an axial direction at a distance from the second group 244.

The first group 242 is essentially arranged in the end area 246 of the feed casing 114 that is turned toward the fourth wall section 220 of the first housing part, whereas the second group 244 is essentially arranged in the end area 248 of the feed casing 114 turned way from the fourth wall section 220 of the first housing part 104.

The cams 120a, 120b, 120c, 120d of the first group 242 work together with the cam feeds assigned to them 122a, 122b, 122c, 122d in such a way that for each the position of the rotation compartment 110 in the perimeter direction at each rotation angle is defined in an essentially unique and repeatable manner.

In a corresponding manner, the cams 120e, 120f, 120g, 120h of the second group work together with the cam feeds 122e, 122f, 122g, 122h assigned to them.

Please note that instead of the two groups 242, 244 there can also be one group or more than two groups. In addition, the number of cams assigned to a group can be selected differently in order to determine a position at each rotation angle of the rotation compartment 110 in an essentially unique manner. For example, three cams can be equipped with corresponding assigned cam feeds. It is also preferable that neighboring cams of a group—at least partially—are separated against each other with a gap in an axial direction. Furthermore, the sequence of the cams in an axial direction can be arranged differently.

In a preferred configuration the cams assigned to the same group 242, 244 can vary in their size.

Preferably, the cams 120a, 120b, 120c, 120d assigned to the first group 242 are arranged in a mirror symmetrical manner to the cams 120e, 120f, 120g, 120h assigned to the second group 244 and with respect to a symmetry level that is arranged perpendicular to the length axis of the rotation compartment 110. If necessary, the entire rotation compartment 110 is formed in a mirror symmetrical manner with respect to this symmetry level.

The interior contour of the feed casing 114 is non-rotational symmetrical and elliptical and preferably adapted to the exterior contour of the pencil 116 that has an elliptical cross-section surface perpendicular to its length axis.

The cap 102 can be connected in a detachable manner with the first housing part 104. The configuration of the cap 102 is cylindrical in this application example. The cap 102 can be configured so that is closes—turned away from the housing and catches shavings that are cast off during sharpening.

FIG. 13 shows the sharpener 100 viewed from the line 13-13 in FIG. 12.

FIG. 13 illustrates the elliptical configuration of the housing casing 160, which limits an elliptical interior space 106a. Furthermore, FIG. 13 shows the cylindrical configuration of the cap 102. The knife blade 112 that runs through the slit 112b provided in the fourth wall section 220 in the interior space, which is fastened to the fourth wall section 220 in a detachable manner by means of a screw 11, as a cutting edge 112a.

FIG. 13 further illustrates the elliptical configuration of the opening cross-section 104a of the opening 218 facing the second housing part 106 and the circular configuration of the opening cross-section 104b of this opening 218 facing away from the second housing part 106.

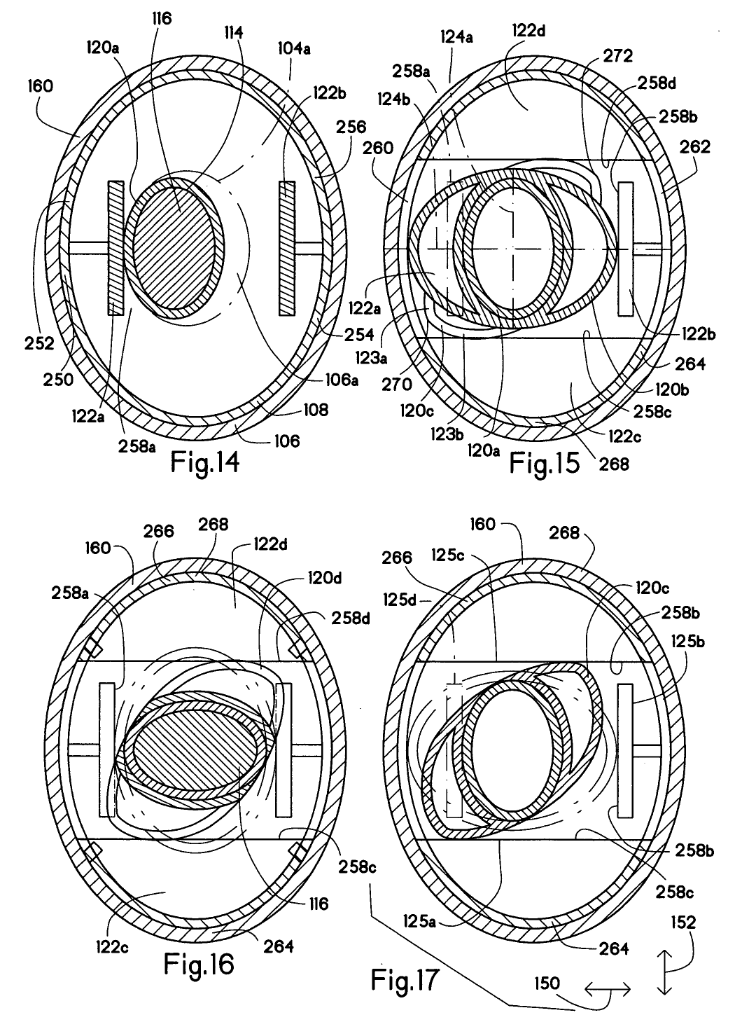

FIG. 14 shows the sharpener 100 from the view of the line 14-14 in FIG. 12.

The housing compartment 108 is set into the housing casing 160 using a light pressure fitting, whereby both parts of this housing compartment 108 are supported on one another by the flaps 250, 252, 254, 256 running in the perimeter direction.

FIG. 14 also shows the first cam feed 122a, as well as the second cam feed 122a. The first feed surface 258a of the first cam feed 122a and the second feed surface 258b of the second cam feed 122b are formed evenly and spaced in an axial direction toward each other and arranged parallel to one another.

The first cam 120a makes contact in a minimum of one rotation setting, like the first cam feed 122a shown in FIG. 14. Preferably, the first cam 120a will make contact with the first cam feed 122a in each rotation position.

FIG. 15 shows a view along line 15-15 in FIG. 12.

The rotation position of the rotation compartment 110 in FIG. 15 corresponds to that in FIG. 14.

The cutaway display in FIG. 15 is seen in an axial direction opposite that from FIG. 14.

As can be seen in the areas 260 and 262 in FIG. 15, the parts 264, 265 of the housing compartment 108 are set in the perimeter direction in the axial position displayed there.

The second, elliptically formed cam 120b, lies on the second cam feed 122b in at least one rotation position, especially in all rotation positions.

The first 120a and the second cam feed 120b are arranged against each other in such a way that each of their large axises stand perpendicular to one another.

Furthermore, FIG. 15 shows the third 122c and the fourth cam feed 122d that run from the exterior wall 268 of the housing compartment 108 inward as a type of separating wall, and are perpendicular to the length axis 118.

The third feed surface 258c of the third cam feed 122c and the fourth feed surface 258d of the fourth cam feed 122d are also configured evenly and in an axial direction to each other and arranged parallel to one another.

The third 258c and the fourth feed surface 258d are also arranged perpendicular to the first 258a and the second feed surface 258b.

The third cam 120c rests on the third cam feed 122c, at least in one rotation position, especially in all rotation positions. The perimeter surface of the third cam has two bent areas that rest on each other with their respective ends so that two transition areas 270, 272 are essentially running between the bent areas. These points 270, 272 lay opposite each other are rotated approximately 45° opposite the large main axis 124a of the first cam 120a similar to a clock hand and approximately 45° opposite the large main axis 124d of the second cam 120b similar to an opposite clock hand. The third cam 120c is configured in such a way that the bending 123a toward the main axis 124b of the second cam 120b is somewhat rounder than the bending 123b that runs in the opposite direction. Furthermore, the third cam 120c in the view level running perpendicular to the length axis 118 is point symmetrical.

FIG. 16 shows a view along the line 16-16 in FIG. 12.

The entire rotation compartment 108 in FIG. 16 is rotated by 90 degrees opposite the position in FIG. 14 and 15.

The fourth cam 120d lies at least on one rotation position, particularly in all, on the fourth cam feed 122d. The fourth cam 120d is mirror symmetrical to the third cam 120c in relation to the large main axis 124b of the second cam 120b.

FIG. 17 shows a view along the line 17-17 in FIG. 12.

The third cam 120c is asymmetrical. The sections 125a thru 125d of the cam feeds 122a thru 122h facing cams 120a thru 120h are essentially configured evenly.

Through the joint operation of the cams 120a thru 120d with the cam feeds 122a thru 122d, the feed casing 114 is held in each position in such a way that the point of a pencil contained in the feed casing 114 is guided along the cutting edge 112a.

Here the concepts of left, right, downward and upward can be understood as follows: Upward and downward direction specifications are understood to be in the cutting level perpendicular to the central length axis 119, which also run in a first direction. Left and right direction specifications are understood to run in a second direction perpendicular to the first direction. The position of the knife blade 112 is defined as upward. The first cam feed 122a prevents the rotation compartment 110 from moving upward by making contact with the first cam 120a. As FIG. 15 shows, the second cam 120b, which is located in an axial direction next to the first cam 120a, presents an upward feed; i.e. it prevents a downward movement of the rotation compartment 110. FIG. 16 shoes the third cam 120c and its cam feed 122c. This prevents leftward movement of the rotation compartment 110 and ensures that the rotation compartment 110 is guided to the right. FIG. 17 shows the fourth cam 120d and the fourth cam feed 122d which work together to make a rightward movement across possible. Viewed from the first housing part 104 outward, there is a corresponding arrangement of four cams 120a thru h and for cam feeds 122g and 122h (two cam feeds cannot be seen) at the back portion of the sharpener, which ensure a more even operation and, in particular jagged edges. The total number of eight cams 120a thru 122h therefore make it possible for the rotation compartment 110 to move in the arrow direction 150 upward or downward upon rotation and in the arrow direction 152 to the left or right (FIG. 17), so that the pencil in lays against the cutting edge in each rotation angle position. The position of the rotation compartment 110 is determined uniquely by each rotation angle.

In a preferred configuration, the rotation compartment 108 with an open housing 103 may only be moved in an axial direction in a limited number of rotation positions, in particular upon assembly. This can, for example, be one or two or three or four or more rotation positions. For the remaining positions, impacts will work in an axial direction, in particular in both orientations of the axial direction.

The impacts can, for example, be configured in such a way that cams in an axial direction strike against neighboring cam feeds under pressure in an axial direction, if necessary, in an alternating manner.

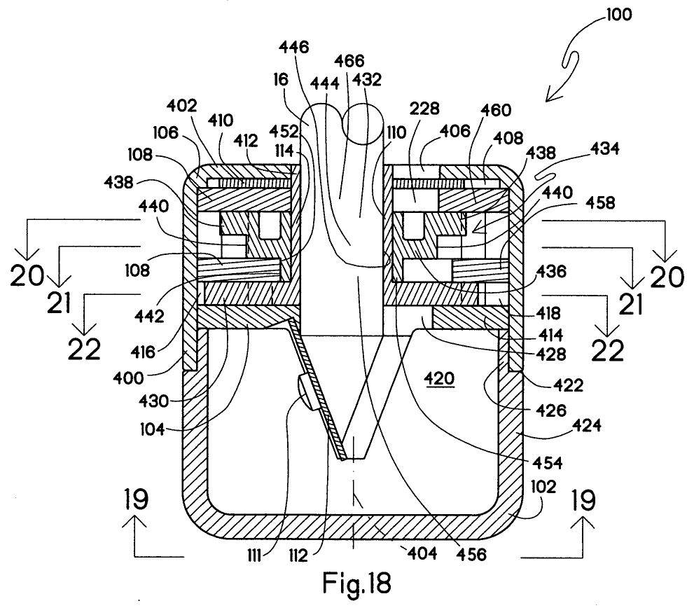

FIG. 18 shows an example configuration of the invention in a schematic display.

The sharpener 100 has a housing with a first housing part 104 and with a second housing part 106.

The second housing part 106 has a first housing wall section 400 and a second housing wall section 402 that is connected firmly and as one piece with the first housing wall section 400.

The first housing wall section 400 of the second housing part 106 is formed in a circular-elliptical manner and runs around a housing length axis 404.

The second housing wall section 402 of the second housing part 106 runs essentially in a radial direction to the housing length axis 404. This second housing wall section 402 is formed as an elliptical plate and has an elliptical opening 406. A circular depression 408 is located on the side of the second housing wall section 402 turned toward the interior of the housing 228 surrounding the opening 406.

A disk-shaped sealing element 410 is contained in this depression. This sealing element 410 has an opening 412. This opening has an elliptical cross-section that is smaller that the elliptical cross-section of the opening 406 that has been provided in the second housing wall section 402. The exterior perimeter contour of the sealing element 410 can, for example, be circular in configuration whereby the diameter of the circle is smaller that the diameter of the circular depression 408.

The first housing part 104 is configured as one piece and connected permanently or detachable with the second housing part 106.

The first housing part 104 has a disk-like area 414 that runs essentially perpendicular to the housing length axis 404. This disk-like area 413 has an exterior perimeter contour running outward in a radial direction that is essentially fitted to the interior perimeter contour of the first housing wall section 400. An opening 416 is provided in a radial direction inside in the disk-like area 414.

A continuation is provided on this disk-like area 414 that runs from this area 414 in the direction away from housing interior space 228 and hold the knife blade 112 by means of a screw 111.

Two flanges 510, 512 are provided in the disk-like area 414 that stands facing inward in front of the radially exterior section of the area 414 in a radial direction and the housing interior space 228. The flanges 510, 512 connect outside with the disk-like area 414 in a radial direction and are each formed as a circular elliptical section and are spaced from each other be a gap 417, 418 in the perimeter direction.

The first housing part 104 is inserted into the second housing part 106 in and axial direction.

If necessary, a cap or a lid 102 is fastened to the housing 103 to create a space 420 for the collection of shavings. This cap 102 can, for example, have an offset 422 in its wall 424 and can be placed, or centered, in or on the first housing wall section 400 with an area 426 connecting to this offset.

Furthermore, an elliptical opening 428 is provided in the disk-like area 414 of the first housing part 104 through which the pencil 16 can reach to the knife blade 112.

There is a rotation compartment 110 arranged in the housing interior 228 that has a feed casing or box 114 and a support section 430 that runs essentially in a radial direction to the length axis 404. This support section 430 is configured in such a way that it can absorb any tipping momentum that have an effect on the feed casing around an axis, which is aligned perpendicular to the housing axis 404.

In the configuration illustrated in FIG. 18, this support section 430 is configured as a disk with a round exterior perimeter contour which is arranged in an axial direction at the end of the feed casing 114 and is connected with it as one piece. This disk can support itself on the disk-like area 414 of the first housing part 104 and/or on the housing compartment 108. The opening provided in this support section 430 corresponds —in particular with respect to the contour—to the opening 432 that is provided in the feed casing 114.

In the configuration shown in FIG. 18 there is also a cam arrangement 434 that is configured as a one-piece cam compartment 436 with three cams 438, 440, 442 arranged next to each other in a radial direction.

This cam compartment 436 has an opening 444 that is configured in such a way that the exterior top surface 446 of the feed casing 114 can be received in a form-fitting manner and essentially or approximately closed.

Each of the cams 438, 440, 442 works together with a cam feed 448, 450, 452. Accordingly, these cam feeds 448, 450, 452, of which cam feed 452 is shown in FIG. 16, are also set in an axial direction and arranged next to each other.

The third cam feed 452 is formed by the interior top surface 454 of an opening 456 that is provided in a first wall section 456 of the housing compartment 108 that runs in a radial direction.

There is a second wall section 460 of the housing compartment 108 provided that runs in a radial direction and is at a distance in an axial direction from the wall section 458 that runs in a radial direction.

On the first 458 and the section wall section 460 that run in a radial direction there is a respective protruding bridge 462, 464 that is essentially formed straight and elongated. These bridges 460, 462 serve as first 448 and a second cam feed 450 for the first 438 and second cam 440.

On one of the wall sections 458, 460, two flanges or wall sections 492, 494 that run in an axial direction and in a perimeter direction have been arranged on the outside in a radial direction, which are spaced in the perimeter direction and are therefore not displayed in the cutaway view of FIG. 18.

An opening 466 has been provided in the second wall section 460 of the housing compartment 108 that runs in a radial direction through which the feed casing 114 runs.

The first 438 and the second 440 cam are arranged in an axial direction between the first 458 and second wall section 460 of the housing compartment 108 running in a radial direction.

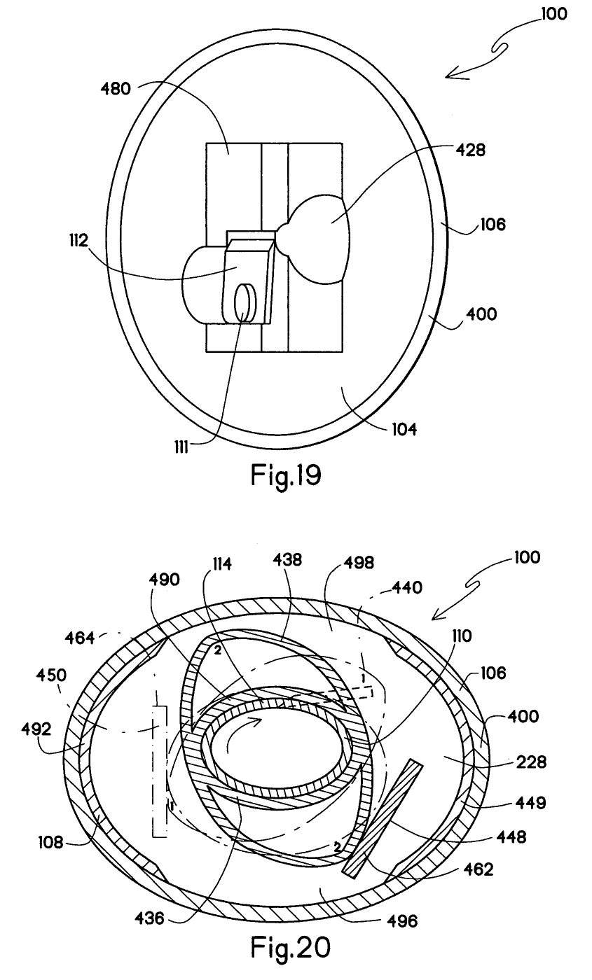

FIG. 19 shows a view along the line 19-19 from FIG. 18 with the lid 102 removed.

The first housing wall section 400 of the second housing part 106 can be seen in FIG. 19.

The second housing part 104 is compartment in this first housing wall section 400, upon which an extension 480 is provided that houses the knife blade 122 by means of a screw 111.

Furthermore, a section of the opening 428 of the first housing part 104 can be seen.

FIG. 20 shows a cutaway view along the line 20-20 from FIG. 18 displayed at a 90° rotation.

FIG. 20 shows the cam compartment 436, which contains the first cam 438 and the second cam 440. The cams 438, 440 are connection firmly with a casing 490 whose top surface forms the third cam 442 on a level offset in an axial direction.

FIG. 20 also shows the feed casing 114.

The cam compartment 436 and the casing 490 of the cam compartment 436 are arranged around this feed casing 114 in a perimeter direction and in a form-fitting manner.

FIG. 20 also shows the first cam feed 448 configured as a bridge 462 and—designated with cross-hatches—the second cam feed 450 configured as a bridge 464.

FIG. 20 also shows two wall sections 492, 494 arranged firmly on the radial wall section 458 of the housing compartment 108 and running in a radial direction on the outside in a perimeter direction as well as an axial direction, between which there are gaps 469, 498 seen in the perimeter direction.

The respective first 438 and/or second cam 440 can be situated into these gaps in the appropriate rotation position.

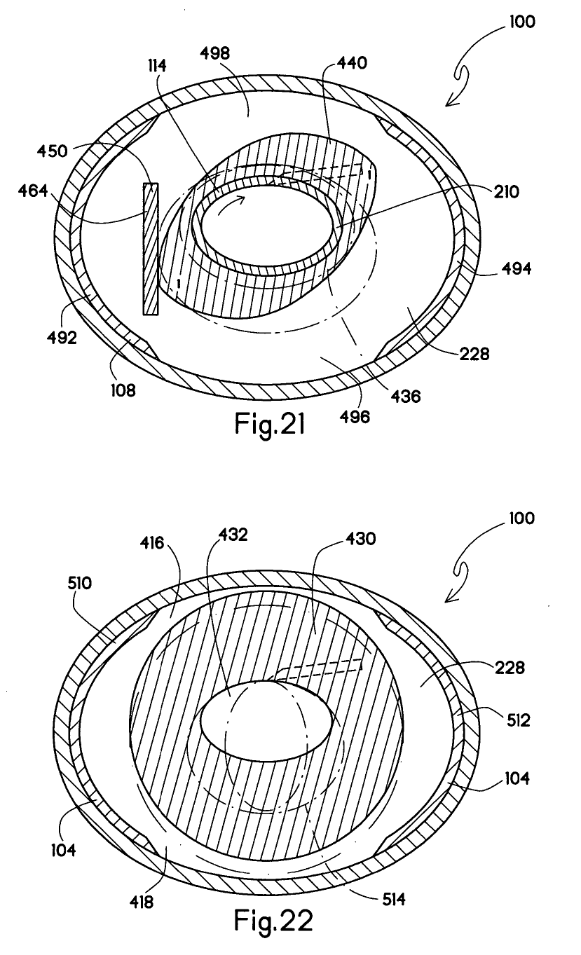

FIG. 21 shows a cutaway view of the configuration in FIG. 18 along the line 21-21 displayed at a 90° rotation.

FIG. 22 shows a cutaway view of the configuration in FIG. 18 along the line 22-22 displayed at a 90° rotation.

FIG. 22 also displays the disk-like area 414 of the flanges 510, 512 of first housing part 104, which are positioned in an axial direction from the exterior radial section of the area 414 and facing the housing interior space 228. The gaps 416, 418 in the perimeter direction between these flanges 510, 512 are also displayed.

FIG. 22 also shows the support section 430—configured as a disk here—as well as the opening 432 running through this support section 430 and the feed casing 114.

The opening 428 of the first housing part 104 is designated by the line 514, which in FIG. 22 is partially covered by the support section 430.

The position of the support section 430 and the opening 432 are designated by the line 430 and 432, where it is shown when a pencil or the feed casing 114 is rotated during sharpening by 90 degrees opposite the position described previously in FIG. 22. As can be seen from this various positions of the support section, this support section runs temporarily—in particular in an alternating manner—into the gaps 418, 418 upon sharpening.

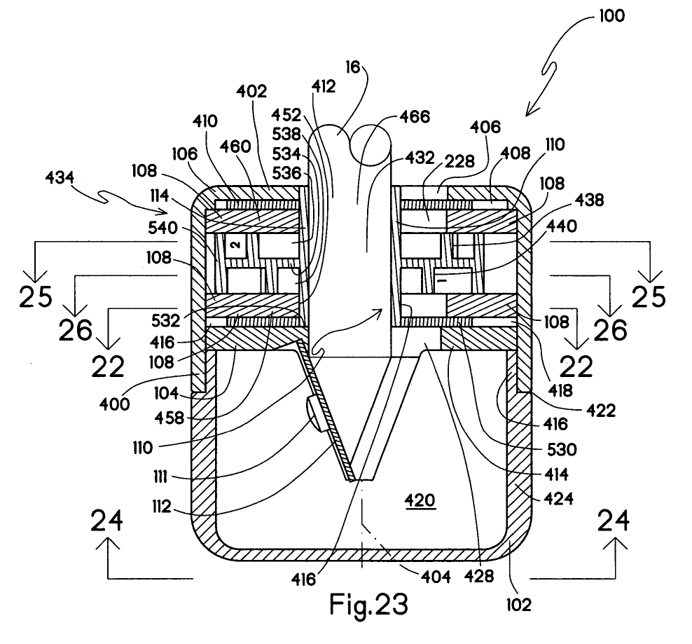

FIG. 23 shows an example configuration of the invention in a schematic display.

The sharpener 300 shown in FIG. 23 differs from the example configuration shown in FIG. 18, in particular through the configuration of the rotation compartment 110 and the configuration of the cam arrangement 434.

The rotation compartment 110 is connected as one piece in with the cam arrangement 434 in the example configuration shown in FIG. 23. Further the rotation compartment 110 as shown in the configuration in FIG. 23 does not have the disk 430 described in FIG. 18 which is arranged in that configuration between the housing compartment 108 and the disk-like area of the housing compartment 104.

In the configuration shown in FIG. 23 there is another sealing device 410 or sealing disk 530 in the appropriate position. The sealing devices 410 and 530 are—seen in an axial direction—arranged on different sides of the housing compartment 108. The sealing device or sealing disk 530 has an opening 532 inside in a radial direction through which the feed casing 114 of the rotation compartment runs.

The cam arrangement 434 is arranged in the example configuration in FIG. 23 so that the first 438 and second cam 440 are arranged on both axial sides of a disk 534 running in a radial direction, which can make contact with the resection cam feed 448 or 450 outside in a radial direction.

In a radial direction, there is gap 536 or 538 that is free of material between the first 438 or second cam 440 and the feed casing 114.

Furthermore in the configuration given in FIG. 23, there are flanges 540, 542 provided at the radial exterior end of the disk 534 running in sections in the perimeter direction, which, for example, each run along a section of an orbit and are spaced with gaps 544, 546 in the perimeter direction.

In the configuration shown in FIG. 23, the third cam 442 is formed from a top surface area of the feed casing 114.

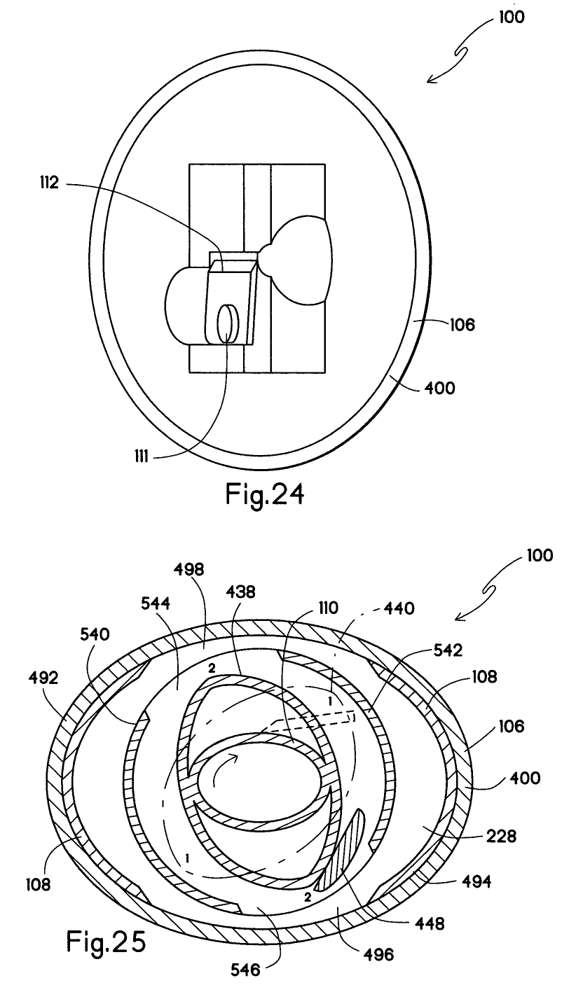

FIG. 24 shows a cutaway view of the configuration shown in FIG. 23 along the line 24-24 displayed at a 90° rotation with the lid 102 removed.

FIG. 25 shows a cutaway view of configuration shown in FIG. 23 along the line 25-25 displayed at a 90° rotation.

FIG. 25 shows that the feed casing 114 of the rotation compartment 110 is connected as one piece with the first cam 438.

Furthermore, FIG. 25 shoes a first cam feed 448 rounded off outwardly in a radial direction formed evenly inward in a radial direction. The first cam feed 448 enters into the gap 546 and, if necessary into the gap 544 at the corresponding rotation position of the rotation compartment 110.

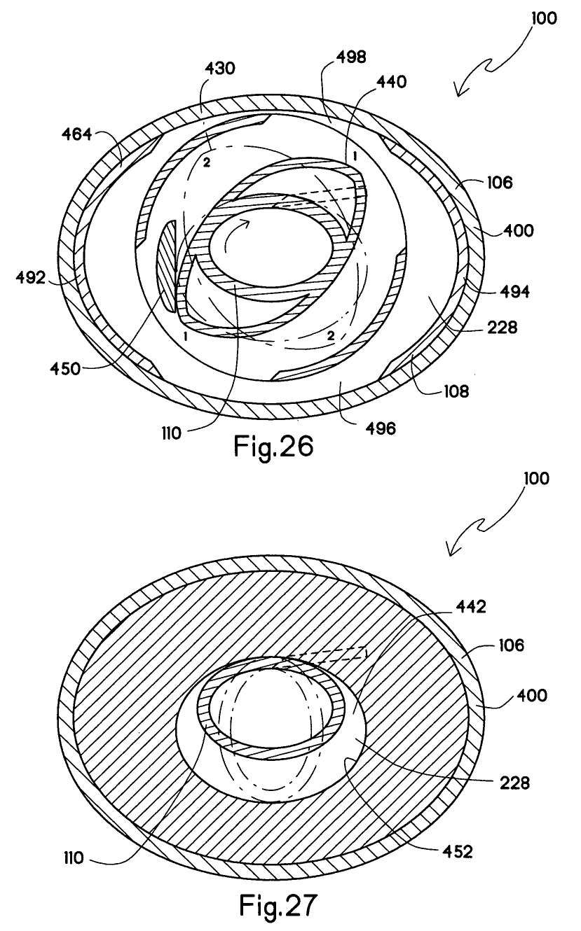

FIG. 26 shows a cutaway view of the configuration shown in FIG. 23 along the line 26-26 displayed at a 90° rotation.

FIG. 26 illustrates that the feed casing 114 of the rotation compartment 110 is connected as one piece with the second cam 440.

Furthermore, the second cam feed 450 as shown in FIG. 26 is configured in such a way as it would be illustrated using FIG. 25 in relation to the first cam feed 448.

FIG. 27 shows a cutaway view of the configuration shown in FIG. 23 along the line 27-27 displayed at a 90° rotation.

FIG. 27 shows that the third cam 442 is formed from an area of the feeding case 114 or an area of the exterior top surface of the feeding case 114.

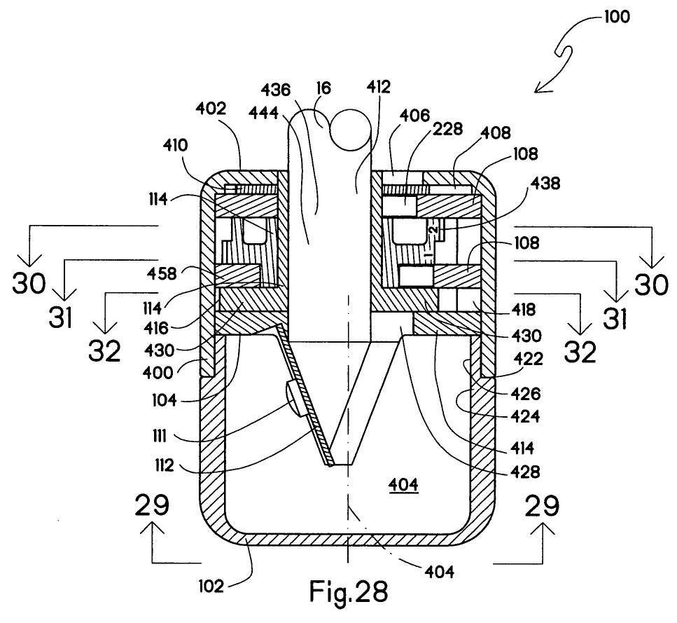

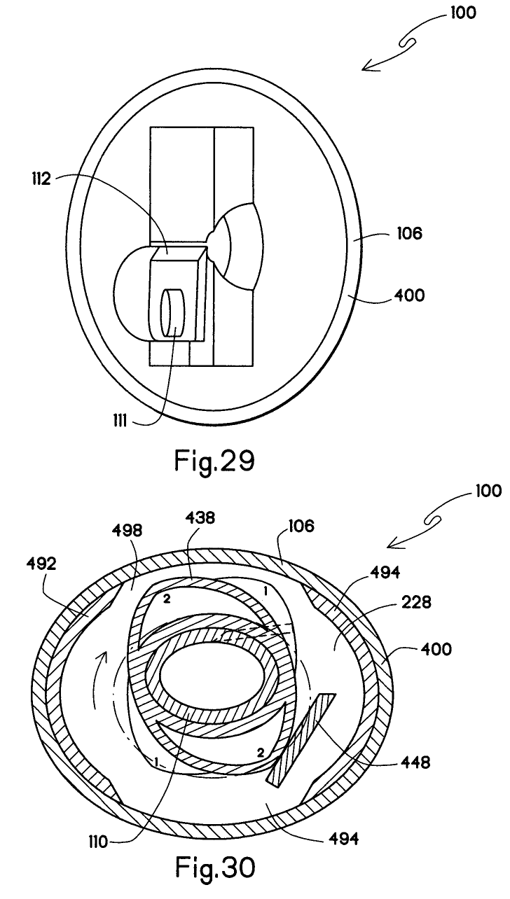

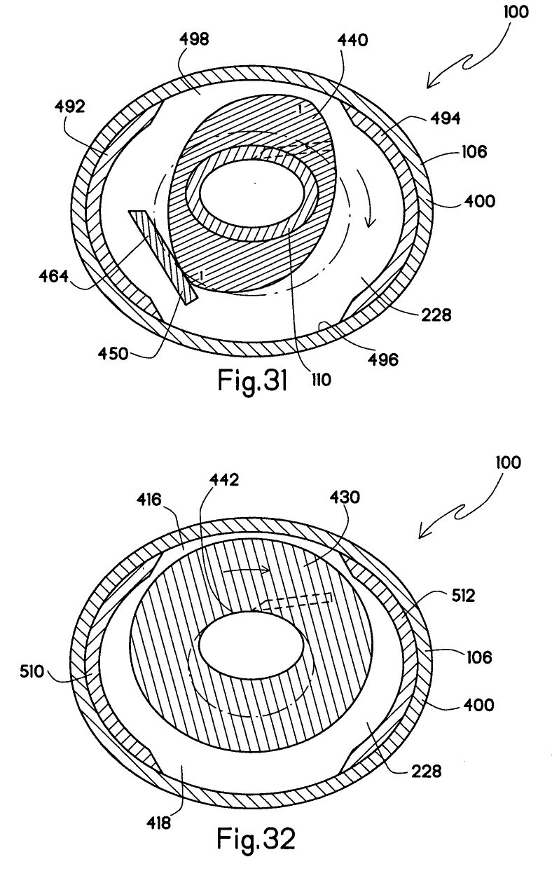

FIG. 28 through 32 show different views or cutaway views of an example configuration of the invention that resemble the configuration illustrated in FIG. 18 thru 22.

The configurations in FIG. 28 and 32, on the one hand, and FIG. 18 thru 22, on the other, differ from each other, besides geometry and in particular the geometry of the cams 438, 440, 442, through the relative arrangement of the first cam feed 448 opposite the second cam feed 450.

Whereas these cam feeds 448, 450 and their standards in the configuration in FIG. 18 thru 22 encircle and angle of approximately 145 degrees, this angle in the configuration in FIG. 28 thru 32 is 120 degrees. It can be noted, however, that other angle ratios may be preferred in the invention.

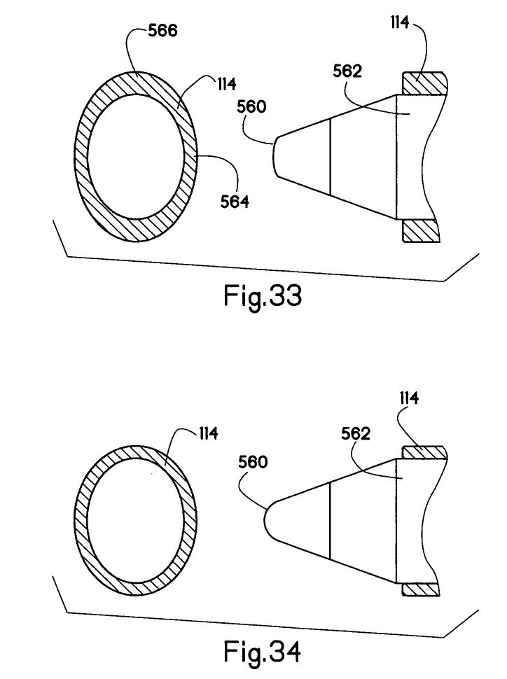

FIG. 33 and 34 each show a partial cutaway of an example configuration of the invention in schematic form.

FIG. 33 and 34 show an example of how the shape of the point 560 can be formed.

FIG. 33 and 34 each show on one side a cross-section through a feed casing 114 and a section of this feed casing 114 with a section of a pencil 562 arranged in it.

In the configuration shown in FIG. 33, the feed casing 114 has a wall thickness that is not constant in the perimeter direction. In this example configuration, the thinnest wall thickness 564 is in the area of the small main axis of the ring-shaped, elliptical cross-section and the thickest wall thickness 566 is in the area of the large main axis.

A relatively flat point 560 of the pencil 562 to be sharpened—in comparison to the configuration in FIG. 34—can be achieved by means of this feed casing 114.

The configuration in FIG. 34 has a constant wall thickness of the feed casing 114 in the perimeter direction.

The feed casings 114 shown in FIG. 33 and 34 can be used in the configurations shown in FIG. 18 thru 32.

1. A sharpener for pencils, and especially for pencils with a rotation-symmetrical cartridge or for pencils whose cartridge is arranged inside of a cartridge carrier, whose cross-section runs perpendicular to the length axis is non-hexagonal and non-circular, comprising:
at least one housing;
a cutting device that is connected with this housing;
a holding device for the pencil that is at least partially contained in the housing; and
a force feed device which guides the holding device along a pre-determined movement path in this housing.

2. The sharpener of claim 1 characterized by the fact that said force feeder has at least one feed element and at least one feed track into which said feed element is inserted.

3. The sharpener of claim 2 characterized by the fact that the feed element is a feed pencil.

4. The sharpener of claim 2 characterized by the fact that the feed track is a groove.

5. The sharpener of claim 2 characterized by the fact that the shape of the feed track essentially matches the outer contour of a cross-section surface of a cutting surface that creates contact between the cutting device and the pencil.

6. The sharpener of claim 1 characterized by a feed disk, which runs outward in a radial direction from the holding device and has at least one groove for receiving a feed element which is arranged firmly opposite the housing.

7. The sharpener of claim 1 characterized by the fact that the cutting device is arranged firmly opposite the housing.

8. The sharpener of claim 1 characterized by the fact that the pencil in the holding device is contained in the holding device in a rotationally fixed manner and the holding device is arranged opposite the cutting device in a movable manner.

9. The sharpener of claim 1 characterized by the fact that the pencil is contained in the holding device in the direction of the pencil length axis and is movable in an axial direction.

10. The sharpener of claim 1 characterized by the fact that the pencil is guided opposite the cutting device by means of a force-feed device upon sharpening in such a way that the free angle is between 2° and 10°.

11. The sharpener of claim 10 characterized by the fact that the free angle is essentially constant when sharpening the pencil.

12. The sharpener of claim 2 characterized by the fact that at least one sealing device is used to insulate the feed tracks.

13. The sharpener of claim 1 characterized by the fact that that sharpener is made at least partially from synthetic materials.

14. The sharpener of claim 1 characterized by the fact that there is at least one container for receiving shavings.

15. The sharpener of claim 1 characterized by the fact that the sharpener can be used to generate non-rotation symmetrical cutting surfaces.

16. The sharpener of claim 1 characterized by the fact that a feed disk is guided between two plane surfaces whereby the plane surfaces prevent movement of the feed disk in an axial direction.

17. The sharpener of claim 1 characterized by the fact that there is cover device for at least partial covering of an opening in the housing, through which the pencil can be inserted into the interior of the housing, whereby this cover is spring-loaded and lays on the housing.

18. The sharpener of claim 1 characterized by the fact that there is a rotation compartment at least partially in the housing and moves there upon rotation around the length axis on a pre-determined path.

19. The sharpener of claim 18 characterized by the fact that the rotation compartment has a feed casing in which a pencil can move in an axial direction, whereby a rotation of the pencil around its length axis causes the rotation of the rotation compartment with the feed casing.

20. The sharpener of claim 18 characterized by the fact that the rotation compartment has a feed casing and cams connected firmly with this casing.

21. The sharpener of claim 18 characterized by the fact that the rotation compartment as at least three cams.

22. The sharpener of claim 20 characterized by the fact that the interior space of the housing is equipped with cam feeds which work together with the cams.

23. The sharpener of claim 22 characterized by the fact that at least one of the cam feeds has a section facing one of the cams thru, which runs essentially straight or evenly.

24. The sharpener of claim 20 characterized by the fact that at least one of the cams thru is formed by a part of the exterior surface of the feed casing.

25. The sharpener of claim 20 characterized by the fact that the cams thru are formed elliptically or asymmetrically.

26. The sharpener of claim 22 characterized by the fact that at least three cams thru and cam feeds thru face each other and essentially define the position of the rotation compartment uniquely at each rotation angle.

27. The sharpener of claim 20 characterized by the fact that the rotation compartment has at least two groups of cams and are spaced from each other in an axial direction.

28. The sharpener of claim 18 characterized by the fact that the rotation compartment can be moved in an axial direction in a maximum of three positions in the housing whereby the position is defined by an angle range that is preferably less than 10 degrees or preferably less than 5 degrees, or preferably less than 3 degrees or preferably less than 2 degrees or preferably less than 1 degree.

29. The sharpener of claim 1 characterized by the fact that the pencil point, upon rotation around the length axis at each rotation position lays on the blade edge of the knife blade.

30. The sharpener of claim 1 characterized by the fact that a rotation compartment is provided that has a feed casing in which a pencil can be received, in particular in a form-fitting manner and a support section that can be used to support this rotation compartment in an axial direction.

31. The sharpener of claim 30 characterized by the fact that the support section is formed as a section running in a radial direction.

32. The sharpener of claim 1 characterized by the fact that the feed casing has a non-constant wall thickness in the perimeter direction.

33. The sharpener of claim 30 characterized by the fact that the path of the wall strength of the feed casing in the perimeter direction influences the shape of the point of the pencil to be sharpened.

34. The sharpener of claim 31 characterized by the fact that the support section is formed to be plate-like.

35. The sharpener of claim 30 characterized by the fact that that support section is arranged at the end of the feed casing in an axial direction.

36. The sharpener of claim 30 characterized by the fact that the support section is supported on a housing section, in particular in an axial direction, and in particular on a housing wall section that runs essentially in a radial direction.

37. The sharpener of claim 1 characterized by the fact that a housing compartment is provided.

38. The sharpener of claim 37 characterized by the fact that the housing compartment is configured in a multi-part fashion, in particular as a two-piece construction.

39. The sharpener of claim 37 characterized by the fact that the housing compartment has a separation layer this is aligned essentially perpendicular to the length axis.

40. The sharpener of claim 37 characterized by the fact that at least three cam feed surfaces are arranged on or in the housing compartment.

41. The sharpener of claim 37 characterized by the fact that at least two cams are arranged within the housing compartment.

42. The sharpener of claim 37 characterized by the fact that at least one cam is supported on the housing compartment in an axial direction and, in particular, on the interior side of the housing compartment.

43. The sharpener of claim 37 characterized by the fact that in the housing compartment, there are at least two cam feeds.

44. The sharpener of claim 37 characterized by the fact that the housing compartment has a wall on both sides in an axial direction that runs essentially in a radial direction, each of which is provided with an opening, preferably elliptical, through which a feed casing can be inserted.

45. The sharpener of claim 30 characterized by the fact that the support section is supported in an axial direction on a wall of a housing compartment that runs in a radial direction.

46. The sharpener of claim 45 characterized by the fact that a wall of an opening that is provided in the wall of the housing compartment running in a radial direction, is a feed surface.

47. The sharpener of claim 41 characterized by the fact that at least one cam, and in particular a cam seat, such as a one-piece cam seat with several cams has an opening inside in a radial direction that runs in an axial direction and this cam or this cam set with this opening is placed on the feed casing.

48. The sharpener of claim 30 characterized by the fact that at least three cams are connected with the feed casing as one piece.

49. The sharpener of claim 1 characterized by the fact that the housing is insulated either on an end wall or on both walls.

50. The sharpener of claim 1 characterized by the fact that at least two cam feeds are arranged toward each other at an angle of 120 degrees.
